(19) United States
(12) Patent Application Publication
(10) Pub. No.: US 2026/0139943 A1
(43) Pub. Date: May 21, 2026

(54) THREE-DIMENSIONAL SHAPE MEASUREMENT DEVICE AND THREE-DIMENSIONAL SHAPE MEASUREMENT METHOD

(71) Applicant: KONICA MINOLTA, INC., Tokyo (JP)

(72) Inventors: Makoto OOKI, Toyohashi-shi (JP); Akihiro NAKAMURA, Shinagawa-ku (JP); Tomoyoshi YUKIMOTO, Hachioji-shi (JP); Yasuyuki KAMAI, Toshima-ku (JP); Katsunori TAKAHASHI, Hachioji-shi (JP)

(21) Appl. No.: 19/386,741

(22) Filed: Nov. 12, 2025

(30) Foreign Application Priority Data
Nov. 18, 2024 (JP) 2024-200601

(51) Int. Cl. G01B 11/25; G06T 7/55

(52) U.S. Cl. CPC G01B 11/254; G06T 7/55

(57) ABSTRACT

A three-dimensional shape measurement device includes: a projector to project a fringe pattern; multiple cameras having a measurable working distance range, respectively; and a processing circuitry to analyze the fringe pattern captured by the multiple cameras, using a phase shift method, to acquire three-dimensional information of an object. The multiple cameras are all arranged on one side of the projector. A projector optical axis of the projector and camera optical axes of the multiple cameras are arranged in the same plane. The camera optical axes are arranged such that interior angles between the camera optical axes and the projector optical axis are different from each other.

### CROSS REFERENCE TO RELATED APPLICATION

The present invention claims priority under 35 U.S.C. § 119 to Japanese Patent Application No. 2024-200601 filed on 18 Nov. 2024, the disclosures of all of which are hereby incorporated by reference in their entireties.

### BACKGROUND OF THE INVENTION

### Field of the Invention

The present invention relates to a three-dimensional shape measurement device and a three-dimensional shape measurement method.

### Description of the Related Art

A generally known three-dimensional shape measurement device uses a phase shift method to measure a three-dimensional shape of an object to be measured. Most of the three-dimensional shape measurement devices each include a single projector and a single camera. Such a three-dimensional shape measurement device has a limited measurement range in the vertical direction, to have difficulty in improving the measurement accuracy. Accordingly, a three-dimensional shape measurement device has been proposed (see Japanese Patent Application Publication No. 2018-146521 (hereinbelow, referred to as Patent Literature 1), for example) that has a measurement range expanded in the vertical direction, in order to improve the measurement accuracy. The device described in Patent Literature 1 is provided with two cameras of a first imager and a second imager, which have different focal lengths from each other, on both sides of a projector, and captures by the cameras images of pattern light projected onto ranges at predetermined distances from the projector, to acquire three-dimensional information from the captured images. The device described in Patent Literature 1 captures images in two ranges at different distances from the cameras, with two cameras having different focal lengths, to expand a measurement range in the vertical direction.

### SUMMARY OF THE INVENTION

The related art described in Patent Literature 1 is desired to balance increasing a measurement range in the vertical direction to improve the measurement accuracy and reducing a unit size, as described below.

A three-dimensional shape measuring using a phase shift method, for example, can further improve the measurement accuracy in the vertical direction by capturing an image with a camera from a direction inclined at a larger angle to a projector optical axis of the projector. It is thus necessary to locate the camera away from the projector in order to improve the measurement accuracy in the vertical direction. Then, the related art described in Patent Literature 1 is provided with two cameras (a first imager and a second imager) having different focal lengths on both sides of the projector, in order to expand a measurement range in the vertical direction to improve the measurement accuracy. However, providing two cameras on both sides of the projector increases the unit size. Accordingly, for expanding a measurement range in the vertical direction to improve the measurement accuracy, the related art described in Patent Literature 1 needs to have the unit size increased. Then, it is desired to balance expanding a measurement range in the vertical direction to improve the measurement accuracy and reducing a unit size.

The present invention has been devised to solve the above-described problem and is intended to provide a three-dimensional shape measurement device and a three-dimensional shape measurement method that expand a measurement range in the vertical direction and reduce a unit size.

The present invention provides a three-dimensional shape measurement device to solve the above-described problem, and the three-dimensional shape measurement device includes: a projector to project a fringe pattern; multiple cameras having measurable working distance ranges, respectively; and a processing circuitry to analyze the fringe pattern captured by the multiple cameras, using a phase shift method, to acquire three-dimensional information of an object, wherein the multiple cameras are all arranged on one side of the projector, a projector optical axis of the projector and camera optical axes of the multiple cameras are arranged in the same plane, and the camera optical axes are arranged such that interior angles between the camera optical axes and the projector optical axis are different from each other.

### BRIEF DESCRIPTION OF DRAWINGS

The advantages and features provided by one or more embodiments of the present invention can be fully understood from the detailed description given hereinbelow and the appended drawings which are given by way of illustration only and thus are not intended to define the limits of the present invention, in which:

FIG. 1 shows a schematic configuration of a three-dimensional shape measurement device according to an embodiment;

FIG. 2A illustrates a unit size of the three-dimensional shape measuring device according to the embodiment;

FIG. 2B illustrates a unit size of a three-dimensional shape measurement device of a comparative case;

FIG. 3 illustrates a principle of improving the measurement accuracy in the vertical direction using the three-dimensional shape measurement device according to the embodiment;

FIG. 4 shows examples of various parameters; and

FIG. 5 is a flowchart of operation of the three-dimensional shape measurement device according to the embodiment.

### DESCRIPTION OF THE PREFERRED EMBODIMENTS

Hereinafter, one or more embodiments of the present invention are described with reference to the drawings. However, the scope of the invention is not limited to the disclosed embodiments. It should be noted that the drawings are merely schematic to the extent that the present invention can be fully understood. Accordingly, the present invention is not limited to those illustrated in the drawings. Additionally, common components and similar components in the drawings are denoted by the same reference signs, and duplicated descriptions thereof are skipped.

### Configuration of Three-Dimensional Shape Measurement Device

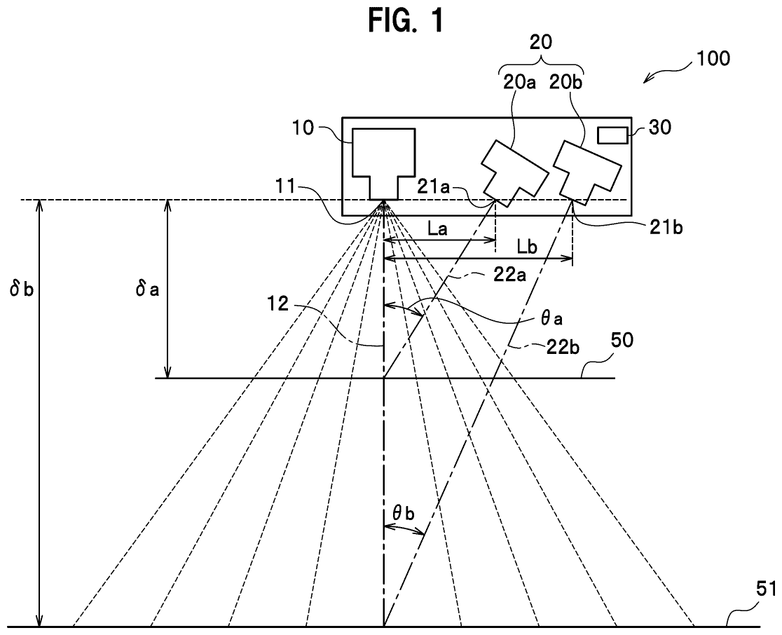

A configuration of a three-dimensional shape measurement device 100 according to the present embodiment is described below with reference to FIG. 1. FIG. 1 shows a schematic configuration of the three-dimensional shape measurement device 100 according to the present embodiment.

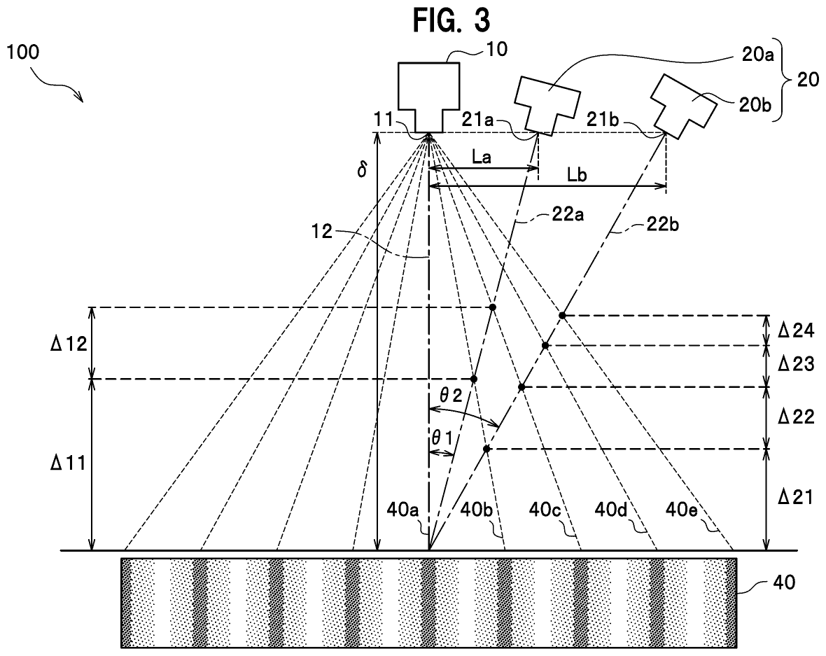

As shown in FIG. 1, the three-dimensional shape measurement device 100 according to the present embodiment includes a projector 10 as a light source, multiple cameras 20 as imagers, and a processing circuitry 30. It is assumed in the present embodiment that the three-dimensional shape measurement device 100 includes the two cameras 20 of a first camera 20a and a second camera 20b. However, the three-dimensional shape measurement device 100 may include the three or more cameras 20. The projector 10 projects a fringe pattern 40 (see FIG. 3). The multiple cameras 20 have measurable working distance range, respectively. Here, the “working distance” means a distance in the vertical direction from a front end of a camera lens 21 to a measured range on which the camera 20 is focused. The processing circuitry 30 analyzes the fringe pattern 40 (see FIG. 3) captured by the multiple cameras 20, using a phase shift method, to acquire three-dimensional information of an object.

The multiple cameras 20 are all arranged on one side of the projector 10. A projector lens 11 of the projector 10, a camera lens 21a of the first camera 20a, and a camera lens 21b of the second camera 20b are arranged horizontally on the same line. A projector optical axis 12 of the projector 10 and camera optical axes 22a, 22b of the multiple cameras 20 are arranged in the same plane. In addition, the camera optical axes 22a, 22b are inclined such that interior angles θa, θb between the camera optical axes 22a, 22b and the projector optical axis 12 are different from each other.

In the example shown in FIG. 1, the two cameras 20 are arranged on the right side of the projector 10 at positions with inter-lens distances La, Lb. The inter-lens distance La is a distance from the projector lens 11 of the projector 10 to the camera lens 21a of the first camera 20a. Likewise, the inter-lens distance Lb is a distance from the projector lens 11 of the projector 10 to the camera lens 21b of the second camera 20b. The inter-lens distance Lb is greater than the inter-lens distance La.

The first camera 20a is focused on a measurement range 50 away from the camera lens 21a by a working distance δa. Likewise, the second camera 20b is focused on a measurement range 51 away from the camera lens 21b by a working distance δb. The working distance δb is greater than the working distance δa.

### Unit Size of Three-Dimensional Shape Measurement Device

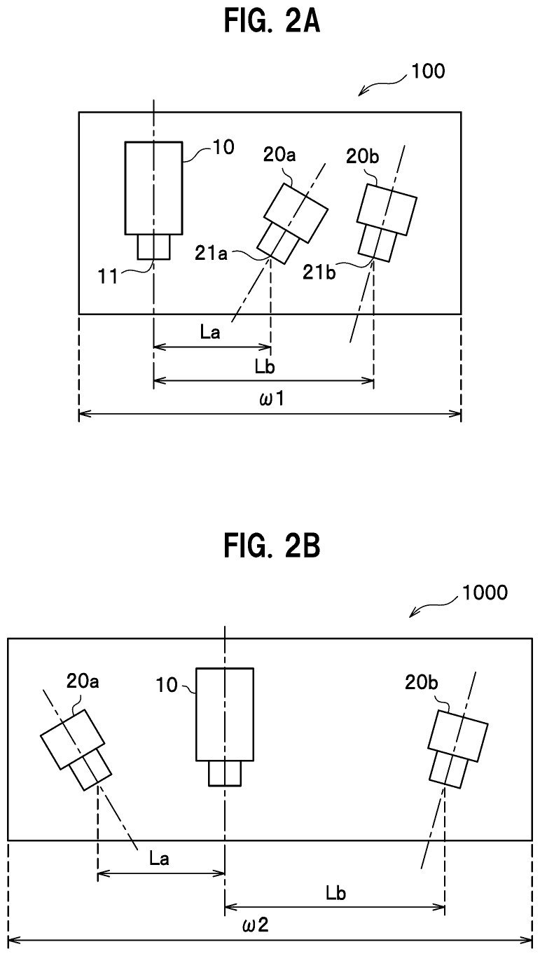

A description is given below of a unit size ω1 of the three-dimensional shape measurement device 100 according to the present embodiment, with reference to FIG. 2A and FIG. 2B. FIG. 2A illustrates a unit size ω1 of the three-dimensional shape measurement device 100. FIG. 2B illustrates a unit size ω2 of a three-dimensional shape measurement device 1000 of a comparative case. The three-dimensional shape measurement device 1000 of the comparative case corresponds to a three-dimensional shape measurement device of the related art.

Here, the description is given on the assumption that the unit size ω1 of the three-dimensional shape measurement device 100 according to the present embodiment and the unit size ω2 of the three-dimensional shape measurement device 1000 of the comparative case are each the sum of the lateral widths of the projector 10, first camera 20a, and second camera 20b.

As shown in FIG. 2A, the three-dimensional shape measurement device 100 according to the present embodiment has the first and second cameras 20a, 20b both arranged on one side (the right side in the drawing) of the projector 10. In the example shown in FIG. 2A, the first camera 20a is located at the inter-lens distance La to the right from the projector 10, and the second camera 20b is located at the inter-lens distance Lb to the right from the projector 10.

In contrast, as shown in FIG. 2B, the three-dimensional shape measurement device 1000 of the comparative case has the first and second cameras 20a, 20b distributed on both sides (the left side and right side in the drawing) of the projector 10. In the example shown in FIG. 2B, the first camera 20a is located at the inter-lens distance La to the left from the projector 10, and the second camera 20b is located at the inter-lens distance Lb to the right from the projector 10.

The unit size ω2 of the three-dimensional shape measurement device 1000 of the comparative case is larger than the unit size ω1 of the three-dimensional shape measurement device 100 according to the present embodiment. Accordingly, the three-dimensional shape measurement device 1000 of the comparative case is larger in size than the three-dimensional shape measurement device 100 according to the present embodiment. In other words, the unit size ω1 of the three-dimensional shape measurement device 100 according to the present embodiment is smaller than the unit size ω2 of the three-dimensional shape measurement device 1000 of the comparative case. Accordingly, the three-dimensional shape measurement device 100 according to the present embodiment is smaller in size than the three-dimensional shape measurement device 1000 of the comparative case.

### Principle of Improving Measurement Accuracy in Vertical Direction using Three-Dimensional Shape Measurement Device

Hereinbelow, a description is given of a principle of improving the measurement accuracy in the vertical direction using the three-dimensional shape measurement device 100, with reference to FIG. 3. FIG. 3 illustrates a principle of improving the measurement accuracy in the vertical direction using the three-dimensional shape measurement device 100. FIG. 3 indicates that capturing an image by the camera 20 from a direction inclined at a larger angle to the projector optical axis 12 further improves the measurement accuracy in the vertical direction.

In the example shown in FIG. 3, the three-dimensional shape measurement device 100 projects the fringe pattern 40 from the projector 10 toward a position of a working distance δ. The fringe pattern 40 is composed of areas of distinct colors (a black area and a white area in the example shown in FIG. 3) that appear at equal intervals. FIG. 3 shows a line connecting a black area corresponding to the projector optical axis 12 with the projector lens 11, as a “fringe correspondence line 40a.”FIG. 3 also shows lines connecting the black areas shifted one by one to the right from the fringe correspondence line 40a with the projector lens 11, as “fringe correspondence lines 40b, 40c, 40d, and 40e.”

In the example shown in FIG. 3, the first camera 20a and second camera 20b are arranged on the right side of the projector 10. The projector lens 11 of the projector 10, the camera lens 21a of the first camera 20a, and the camera lens 21b of the second camera 20b are arranged horizontally on the same line. The camera optical axis 22a of the first camera 20a and the camera optical axis 22b of the second camera 20b are inclined so as to intersect the projector optical axis 12 (i.e., the fringe correspondence line 40a) of the projector lens 11 at a position of the work distances δ. An interior angle θ2 between the camera optical axis 22b of the second camera 20b and the projector optical axis 12 is larger than an interior angle θ1 between the camera optical axis 22a of the first camera 20a and the projector optical axis 12.

In the example shown in FIG. 3, the intervals in the fringe pattern 40 between adjacent lines of the fringe correspondence lines 40a, 40b, 40c, 40d, and 40e each represent a shift amount of one phase for the cameras 20.

For example, the camera optical axis 22a of the first camera 20a intersects the fringe correspondence line 40b at a position upward by a distance Δ11 from the position intersecting the fringe correspondence line 40a. Likewise, the camera optical axis 22a of the first camera 20a intersects the fringe correspondence line 40c at a position upward by a distance Δ12 from the position intersecting the fringe correspondence line 40b. The distance Δ11 represents a shift amount of one phase between the fringe correspondence lines 40a and 40b for the first camera 20a. Likewise, the distance Δ12 represents a shift amount of one phase between the fringe correspondence lines 40b and 40c for the first camera 20a. The distance Δ12 is smaller than the distance Δ11.

The camera optical axis 22b of the second camera 20b intersects the fringe correspondence line 40b at a position upward by a distance Δ21 from the position intersecting the fringe correspondence line 40a. Likewise, the camera optical axis 22b of the second camera 20b intersects the fringe correspondence line 40c at a position upward by a distance Δ22 from the position intersecting the fringe correspondence line 40b. Likewise, the camera optical axis 22b of the second camera 20b intersects the fringe correspondence line 40d at a position upward by a distance Δ23 from the position intersecting the fringe correspondence line 40c. Likewise, the camera optical axis 22b of the second camera 20b intersects the fringe correspondence line 40e at a position upward by a distance Δ24 from the position intersecting the fringe correspondence line 40d. The distance Δ21 represents a shift amount of one phase between the fringe correspondence lines 40a and 40b for the second camera 20b. The distance Δ22 represents a shift amount of one phase between the fringe correspondence lines 40b and 40c for the second camera 20b. The distance Δ23 represents a shift amount of one phase between the fringe correspondence lines 40c and 40d for the second camera 20b. The distance Δ24 represents a shift amount of one phase between the fringe correspondence lines 40d and 40e for the second camera 20b. The distances Δ21, Δ22, Δ23, and Δ24 decrease in this order. Additionally, the distance Δ21 is smaller than the distance Δ11. Likewise, the distance Δ22 is smaller than the distance Δ12.

As can be seen from the positional relationship between the first and second cameras 20a, 20b in FIG. 3, moving a position of the camera 20 farther away from the projector 10 causes a height corresponding to a shift amount of one phase to become lower. In other words, capturing an image with the camera 20 located farther from, and inclined at a larger angle to, the projector optical axis 12 causes a height corresponding to a shift amount of one phase to become lower. Accordingly, when a three-dimensional shape of an object is measured from a captured image of the object, using a phase shift method, capturing an image with the camera 20 located farther from, and inclined at a larger angle to, a projector optical axis allows for decreasing a height with respect to the phase. That is, an image captured by the camera 20 inclined at a larger angle to a projector optical axis can reduce a sensitivity error of a height with respect to a phase. What is actually measured is the phase. Then, even if the same phase error occurs, an image captured by the camera 20 inclined at a larger angle to a projector optical axis can decrease sensitivity of a height with respect to a phase, to allow for reducing a sensitivity error of a height. That is, the three-dimensional shape measurement device 100 can further improve the measurement accuracy in the vertical direction by measuring a three-dimensional shape of an object using an image captured by the camera 20 inclined at a larger angle to a projector optical axis than using an image captured by the camera 20 inclined at a smaller angle to the projector optical axis.

The three-dimensional shape measurement device 100 uses an image captured by the first camera 20a and an image captured by the second camera 20 to measure a three-dimensional shape of the object. At that time, the image captured by the first camera 20a is used to measure a three-dimensional shape in a relatively closer work range and the image captured by the second camera 20b is used to measure a three-dimensional shape in a relatively farther work range, to improve the measurement accuracy in the vertical direction.

### Examples of Various Parameters

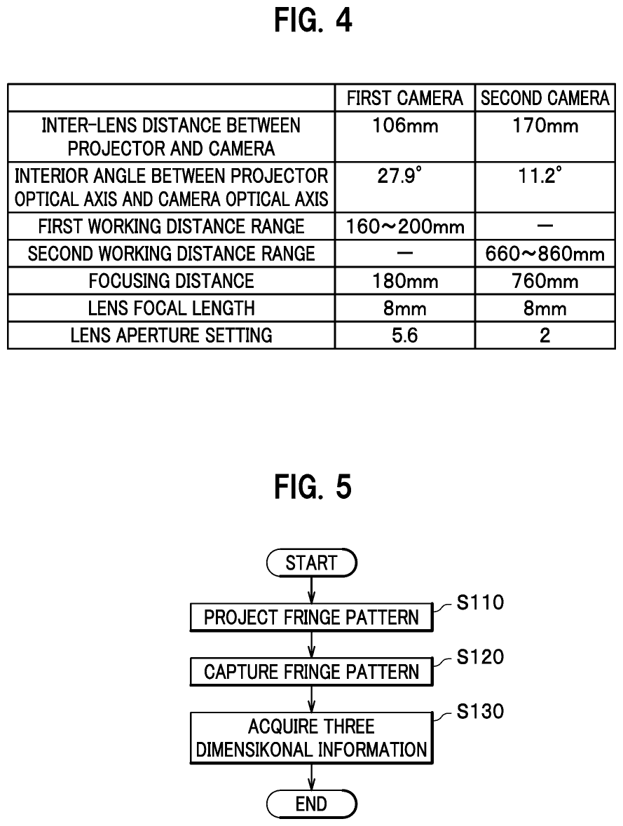

Hereinbelow, examples of various parameters are described with reference to FIG. 4. FIG. 4 shows examples of various parameters. Note that the parameters shown in FIG. 4 are merely examples and can be changed as desired, depending on operation.

In the example shown in FIG. 4, the inter-lens distance between the projector 10 and the camera 20 is set to 106 [mm] for the inter-lens distance La (see FIG. 1) of the first camera 20a and 170 [mm] for the inter-lens distance Lb (see FIG. 1) of the second camera 20b.

The interior angle between the projector optical axis 12 and the camera optical axis 22 is set to 27.9 [°] for the interior angle θa (see FIG. 1) of the first camera 20a and 11.2 [°] for the interior angle θb (see FIG. 1) of the second camera 20b.

The first working distance range (i.e., the range at the working distance δa (see FIG. 1) of the first camera 20a) is set to 160 to 200 [mm]. Likewise, the second working distance range (i.e., the range at the working distance δb (see FIG. 1) of the second camera 20b) is set to 660 to 860 [mm].

The focusing distance of the first camera 20a is set to 180 [mm] and that of the second camera 20b is set to 760 [mm].

The lens focal lengths of the first camera 20a and the second camera 20b are equally set to 8 [mm].

The lens aperture setting of the first camera 20a is set to 5.6 and that of the second camera 20b is set to 2. Note that an aperture value of the lens of the camera 20 is a parameter related to the aperture of the camera 20. Setting a smaller aperture value of the lens of the camera 20 has a similar effect to increasing the aperture of the camera 20.

As a supplementary description for these parameters, it is desirable that the interior angle between the projector optical axis 12 and the camera optical axis 22 be 10° or more, based on the principle of measurement accuracy using a phase shift method. With the present embodiment, the second working distance range (i.e., the range at the working distance δb (see FIG. 1) of the second camera 20b) is set to be a relatively long distance of 660 to 860 [mm]. Accordingly, the inter-lens length Lb (see FIG. 1) between the projector 10 and the second camera 20b is set to 170 [mm] when the interior angle θb (see FIG. 1) between the projector optical axis 12 and the camera optical axis 22 of the second camera 20b is set to 11.2 [°]. When the working distance range is shortened, the inter-lens distance between the projector 10 and the camera 20 is shortened even with the same interior angle between the projector optical axis 12 and the camera optical axis 22. Thus, shortening the working distance range allows the unit size of the three-dimensional shape measurement device 100 to be reduced. Besides, the three-dimensional shape measurement device 100 has the cameras 20 arranged on one side of the projector 10 as shown in FIG. 2A, to allow the unit size ω1 to be smaller than the case where the cameras 20 are arranged on both sides of the projector 10 as shown in FIG. 2B.

Note that shortening a working distance range causes a measurement range to be narrowed. Accordingly, setting (designing) a range of values for the working distance range varies depending on the size of an object to be measured.

The three-dimensional shape measurement device 100 is configured as follows. These configurations are described below in “Main Features of Three-dimensional Shape Measurement Device.” With the present embodiment, the camera 20 located farther from the projector optical axis 12 has a smaller one of the interior angles θa and θb between the projector optical axis 12 and the camera optical axes 22. The multiple cameras 20 are focused on different working distance ranges from each other. In addition, the camera 20 located farther from the projector optical axis 12 is focused on a more distant working distance range from the projector 10. Further, the lens focal lengths of the multiple camera 20 are all set equal. Furthermore, the camera 20 focused on a more distant working distance range from the projector 10 is set to have a smaller aperture value of a lens.

Note that the camera 20 focused on a more distant working distance range from the projector 10 may be set to have a slower shutter speed. In addition, the projector 10 may project fringe patterns with different periods on different working distance ranges. Further, for measurement in a certain working distance range, data acquired by one of the cameras corresponding to the working distance range may be used for measuring a three-dimensional shape in said working distance range. The lens focal length of the projector 10 is preferably fixed.

### Operation of Three-Dimensional Shape Measurement Device

Operation of the three-dimensional shape measurement device 100 is described below with reference to FIG. 5. FIG. 5 is a flowchart of operation of the three-dimensional shape measurement device 100.

As shown in FIG. 5, operation of the three-dimensional shape measurement device 100 includes a fringe pattern projection step (step S110), a fringe pattern capturing step (step S120), and a three-dimensional information acquisition step (step S130). The fringe pattern projection step (step S110) is a step of projecting the fringe pattern 40 (see FIG. 3) by the projector 10. The fringe pattern capturing step (step S120) is a step of capturing the fringe pattern 40 (see FIG. 3) with the multiple cameras 20 having measurable working distance ranges, respectively, and all arranged on one side of the projector 10. The three-dimensional information acquisition step (step S130) is a step of analyzing the fringe pattern 40 (see FIG. 3) captured in the fringe pattern capturing step (step S120), using a phase shift method, to acquire three-dimensional information of the object.

### Main Features of Three-Dimensional Shape Measurement Device

The three-dimensional shape measurement device 100 according to the present embodiment can be configured to have the following features.

1) As shown in FIG. 1, the three-dimensional shape measurement device 100 according to the present embodiment includes the projector 10, multiple cameras 20, and processing circuitry 30. The projector 10 projects a fringe pattern. The multiple cameras 20 have measurable working distance ranges, respectively. The processing circuitry 30 analyzes the fringe patterns captured by the multiple cameras 20, using a phase shift method, to acquire three-dimensional information of the object. The multiple cameras 20 are all arranged on one side of the projector 10. The projector optical axis 12 of the projector 10 and the camera optical axes 22a and 22b of the multiple cameras 20 are arranged in the same plane. Furthermore, the camera optical axes 22a and 22b are inclined such that the interior angles θa and θb between the camera optical axes 22a, 22b and the projector optical axis 12 are different from each other.

The three-dimensional shape measurement device 100 according to the present embodiment can capture images of multiple measurable ranges with the multiple cameras 20 to expand a measured range in the vertical direction. Expanding the measured range in the vertical direction results in increasing a range of sizes of measurable objects (measured objects). Accordingly, the three-dimensional shape measurement device 100 can measure objects in various sizes, from large to small, with a single device and can improve the measurement accuracy. Note that the three-dimensional shape measurement device 100 includes the multiple cameras 20 to have a larger unit size than one including only one camera. However, the three-dimensional shape measurement device 100 has the multiple cameras 20 all arranged on one side of the projector 10. This allows for reducing the unit size of the three-dimensional shape measurement device 100. The three-dimensional shape measurement device 100 as described above can increase the measurement range in the vertical direction to improve the measurement accuracy and reduce the unit size.

2) As shown in FIG. 1, with the three-dimensional shape measurement device 100 of the above item 1), the interior angle θa or θb between the projector optical axis 12 and the camera optical axis 22 is preferably set smaller for the camera 20 located farther from the projector optical axis 12.

The three-dimensional shape measurement device 100 can further improve the measurement accuracy in the vertical direction by measuring a three-dimensional shape of an object using an image captured by the camera 20 inclined at a larger angle to a projector optical axis than using an image captured by the camera 20 inclined at a smaller angle to the projector optical axis. The three-dimensional shape measurement device 100 as described above desirably has the camera 20 as far away from the projector 10 as possible in order to have the camera 20 inclined at a larger angle to the project optical axis. The camera 20 set to have a longer working distance can have a smaller interior angle between itself and the projector optical axis 12. For this reason, with the present embodiment, the second camera 20b set to have a longer working distance is located farther from the projector 10, while the first camera 20a set to have a shorter working distance is located closer to the projector 10. This allows the three-dimensional shape measurement device 100 to improve the measurement accuracy and reduce the unit size.

3) As shown in FIG. 4, with the three-dimensional shape measurement device 100 of the above item 1), the multiple cameras 20 are preferably focused on different working distance ranges, respectively.

The three-dimensional shape measurement device 100 includes the multiple cameras 20 in order to have multiple measurable working distance ranges. With the three-dimensional shape measurement device 100, the cameras 20 are focused on corresponding working distance ranges to allow for improving the measurement accuracy of the three-dimensional shape in the respective ranges.

4) As shown in FIG. 4, with the three-dimensional shape measurement device 100 of the above item 1), the camera 20 located farther from the projector optical axis 12 is preferably focused on a more distant working distance range from the projector 10.

As described in the above item 2), the three-dimensional shape measurement device 100 can further improve the measurement accuracy in the vertical direction, when measuring a three-dimensional shape of an object, using an image captured by the camera 20 inclined at a larger angle to the projector optical axis than using an image captured by the camera 20 inclined at a smaller angle to the projector optical axis. With the three-dimensional shape measurement device 100 as described above, the camera 20 is desirably located as farther from the projector 10 as possible in order to have the camera 20 inclined at a larger angle to the projector optical axis. With the three-dimensional shape measurement device 100 as described above, the camera 20 located farther from the projector optical axis 12 is preferably focused on a more distant working distance range from the projector 10 in order to capture an image of a range at a longer working distance.

5) As shown in FIG. 4, with the three-dimensional shape measurement device 100 of the above item 1), the lens focal lengths of the cameras 20 are preferably set equal to each other.

The three-dimensional shape measurement device 100 of the present embodiment allows the multiple cameras 20 to use the same lens, to reduce manufacturing costs.

6) As shown in FIG. 4, with the three-dimensional shape measurement device 100 of the above item 1), the camera 20 focused on a more distant working distance range from the projector 10 is preferably set to have a smaller aperture value of a lens thereof.

When an aperture value of a lens of the camera 20 is set smaller, a light amount received by the imaging element increases to cause a captured image to be brighter. In such a relationship, the camera 20 to capture an image of a more distant working distance range from the projector 10 has a smaller light amount for a captured image than the camera 20 to capture an image of a working distance range closer to the projector 10. However, with the three-dimensional shape measurement device 100, the camera 20 focused on a more distant working distance range from the projector 10 is set to have a smaller aperture value of the lens, to compensate for shortage of the light amount for the captured image.

7) With the three-dimensional shape measurement device 100 of the above item 1), the camera 20 focused on a more distant working distance range from the projector 10 may have a slower shutter speed.

When the shutter speed is set slower, the light amount received by the imaging element increases to cause the captured image to be brighter. In such a relationship, the camera 20 to capture an image of a more distant working distance range from the projector 10 has a smaller light amount for a captured image than the camera 20 to capture an image of a working distance range closer to the projector 10. In this regard, with the three-dimensional shape measurement device 100, the camera 20 focused on a more distant working distance range from the projector 10 is set to have a slower shutter speed, to compensate for shortage of the light amount for the captured image.

8) With the three-dimensional shape measurement device 100 of the above item 1), the projector 10 may project fringe patterns with different periods onto different working distance ranges.

With the same period of the fringe patterns, the longer the working distance is, the wider intervals between fringes in the captured range becomes. In this regard, the three-dimensional shape measurement device 100 uses fringe patterns with different periods, at different distances, to secure the measurement accuracy of working distance ranges.

9) With the three-dimensional shape measurement device 100 of the above item 1), for measuring a three-dimensional shape in a certain working distance range, data acquired by one of the cameras corresponding to the working distance range may be used.

The three-dimensional shape measurement device 100 includes the multiple cameras 20 for capturing images of different working distance ranges. The three-dimensional shape measurement device 100 as described above preferably uses, for measuring a three-dimensional shape in a certain working distance range, only data acquired by one of the cameras 20 corresponding to the working distance range.

10) With the three-dimensional shape measurement device 100 of the above item 1), the lens focal length of the projector 10 is preferably fixed.

The related art in Patent Literature 1 as described above projects a fringe pattern not by the projector 10 but by laser scanning. If a fringe pattern is projected with the fixed lens focal length of the projector 10, the fringe pattern is defocused in a measurement range at a different distance to deteriorate accuracy of measuring phases. In contrast, the three-dimensional shape measurement device 100 according to the present embodiment captures images with the multiple cameras 20 focused on the different measurement ranges to prevent a fringe pattern from being defocused in a measurement range at a different distance, to improve accuracy of measuring phases. The three-dimensional shape measurement device 100 as described above can constitute a system to project a fringe pattern with the fixed lens focal length of the projector 10.

11) As shown in FIG. 5, the three-dimensional shape measurement method according to the present embodiment includes a fringe pattern projection step (step S110), a fringe pattern capturing step (step S120), and a three-dimensional information acquisition step (step S130). The fringe pattern projecting step (step S110) is a step of projecting the fringe pattern 40 (see FIG. 3) by the projector 10. The fringe pattern capturing step (step S120) is a step of capturing the fringe pattern 40 (see FIG. 3) with the multiple cameras 20 having measurable working distance ranges, respectively, and all arranged on one side of the projector 10. The three-dimensional information acquisition step (step S130) is a step of analyzing the fringe pattern 40 (see FIG. 3) captured in the fringe pattern capturing step (step S120), using a phase shift method, to acquire three-dimensional information of the object. In the fringe pattern projection step and fringe pattern capturing step, the projector optical axis 12 of the projector 10 and the camera optical axes 22 of the multiple cameras 20 are arranged in the same plane. In addition, the camera optical axes 22 of the cameras 20 are inclined such that the interior angles θa and θb between the camera optical axes 22 and the projector optical axis 12 are different from each other.

The three-dimensional shape measurement method according to the present embodiment can implement expanding the measurement range in the vertical direction, improving the measurement accuracy, and reducing a unit size of a device including the projector 10 and camera 20.

As described hereinabove, the three-dimensional shape measurement device 100 according to the present embodiment can expand a measurement range in the vertical direction and reduce a unit size.

Note that the present invention is not limited to the above-described embodiment, and various changes and modifications can be made without departing from the scope of the present invention. The scope of the present invention should be interpreted by the appended claims

For example, the above-described embodiment has been described in detail to illustrate the substance of the present invention. Accordingly, the present invention is not necessarily limited to the one including all the components described above. In addition, the present invention may have a component added with other component and/or have some components changed to other components. Further, the present invention may have some components removed.

### Description of Reference Signs

10: projector, 11: projector lens (lens), 12: projector optical axis, 20: camera, 20a: first camera, 20b: second camera, 21; 21a; 21b: camera lens (lens), 22; 22a; 22b: camera optical axis, 30: processing circuitry, 40: fringe pattern, 40a; 40b; 40c; 40d; 40e; (and so on): fringe correspondence line, 100; 1000: three-dimensional shape measurement device, Δ11; Δ12; Δ21; Δ22; Δ23; Δ24: distance, La; Lb: inter-lens distance, ω1; ω2: unit size, 50; 51: measurement range, δ; δa; δb: working distance, and Θa; θb; θ1; θ2: interior angle.

What is claimed is:

1. A three-dimensional shape measurement device comprising:
a projector to project a fringe pattern;
multiple cameras having measurable working distance ranges, respectively; and
a processing circuitry to analyze the fringe pattern captured by the multiple cameras, using a phase shift method, to acquire three-dimensional information of an object,
wherein the multiple cameras are all arranged on one side of the projector,
a projector optical axis of the projector and camera optical axes of the multiple cameras are arranged in the same plane, and
the camera optical axes are arranged such that interior angles between the camera optical axes and the projector optical axis are different from each other.

2. The three-dimensional shape measurement device, wherein
the interior angle between the projector optical axis and the camera optical axis is set smaller for the camera located farther from the projector optical axis.

3. The three-dimensional shape measurement device according to claim 1, wherein
the multiple cameras are focused on different working distance ranges, respectively.

4. The three-dimensional shape measurement device according to claim 1, wherein
the camera located farther from the projector optical axis is focused on a more distant working distance range from the projector.

5. The three-dimensional shape measurement device according to claim 1, wherein
lens focal lengths of the cameras are set equal to each other.

6. The three-dimensional shape measurement device according to claim 1, wherein
the cameras focused on a more distant working distance range from the projector is set to have a smaller aperture value of a lens thereof.

7. The three-dimensional shape measurement device according to claim 1, wherein
the camera focused on a more distant working distance range from the projector has a slower shutter speed.

8. The three-dimensional shape measurement device according to claim 1, wherein
the projector projects fringe patterns with different periods onto different working distance ranges.

9. The three-dimensional shape measurement device according to claim 1, wherein
for measuring a three-dimensional shape in a certain working distance range, data acquired by one of the cameras corresponding to the working distance range is used.

10. The three-dimensional shape measurement device according to claim 1, wherein
a lens focal length of the projector is fixed.

11. A three-dimensional shape measurement method comprising:
a fringe pattern projection step of projecting a fringe pattern by a projector;
a fringe pattern capturing step of capturing the fringe pattern with multiple cameras having measurable working distance ranges, respectively, and all arranged on one side of the projector; and
a three-dimensional information acquisition step of analyzing the fringe pattern captured in the fringe pattern capturing step, using a phase shift method, and acquiring three-dimensional information of an object,
wherein in the fringe pattern projection step and the fringe pattern capturing step, a projector optical axis of the projector and camera optical axes of the multiple cameras are arranged in the same plane, and the camera optical axes are inclined such that interior angles between the camera optical axes and the projector optical axis are different from each other.
